(19) United States
(12) Patent Application Publication
(10) Pub. No.: US 2024/0387098 A1
(43) Pub. Date: Nov. 21, 2024

(54) COIL ELECTRONIC COMPONENT

(71) Applicant: SAMSUNG ELECTRO-MECHANICS CO., LTD., Suwon-si (KR)

(72) Inventors: Su Min Seo, Suwon-si (KR); Juhwan Yang, Suwon-si (KR); Jae-Hun Kim, Suwon-si (KR); Boumseock Kim, Suwon-si (KR)

(73) Assignee: SAMSUNG ELECTRO-MECHANICS CO., LTD., Suwon-si (KR)

(21) Appl. No.: 18/658,353

(22) Filed: May 8, 2024

(30) Foreign Application Priority Data
May 19, 2023 (KR) 10-2023-0064982

(51) Int. Cl. H01F 27/29; H01F 3/08; H01F 27/28

(52) U.S. Cl. CPC H01F 27/292; H01F 3/08; H01F 27/2823

(57) ABSTRACT

A coil electronic component that includes a body and a coil at least partially embedded in the body, and that has a length L1 in a first direction and a margin in the first direction. The margin in the first direction is an average distance from the coil to a surface of the body intersecting the first direction, and is greater than 0% and less than or equal to 7% of the length L1 in the first direction.

### CROSS-REFERENCE TO RELATED APPLICATION

This application claims priority to and the benefit of Korean Patent Application No. 10-2023-0064982 filed in the Korean Intellectual Property Office on May 19, 2023, the entire contents of which are incorporated herein by reference.

### BACKGROUND

### Technical Field

The present disclosure relates to a coil electronic component.

### Description of the Related Art

Recently, as functions of mobile devices diversify, power consumption increases, and in order to increase battery usage time in mobile devices, passive components with low loss and excellent efficiency are employed around a power management integrated circuit (PMIC). Meanwhile, a demand for a low-profile power inductor is increasing in order to slim a product and increase a degree of freedom in component arrangement.

The power inductors may be broadly categorized into stacked, thin film, and wire wound types according to their structures and production methods. In the case of a wire wound-type inductor, a distance between an end surface in a longitudinal direction of a main body and a coil is large, so it may be insufficient to secure its capacity compared to its volume.

### SUMMARY

An embodiment is to provide a coil electronic component with increased capacity to volume ratio.

However, the objective of the present disclosure is not limited to the aforementioned one, and may be extended in various ways within the spirit and scope of the present disclosure.

An embodiment provides a coil electronic component that includes a body and a coil at least partially embedded in the body. The coil electronic component has a length L1 in a first direction and a first margin in the first direction. The first margin is an average distance from the coil to a surface of the body intersecting the first direction, and is greater than 0% and less than or equal to 7% of the length L1 in the first direction.

The coil electronic component may further include a second margin in a second direction, the second direction intersecting the first direction, wherein the second margin is an average distance from the coil to a surface of the body intersecting the second direction, and is smaller than the first margin.

The body may include a magnetic material, and the magnetic material may include a first metal magnetic powder, a second metal magnetic powder with a larger particle size than the first metal magnetic powder, and a third metal magnetic powder with a larger particle size than the second metal magnetic powder.

An average particle size (D₅₀) of the first metal magnetic powder may be 0.1 μm or more and 0.2 μm or less.

An average particle size (D₅₀) of the second metal magnetic powder may be 1 μm or more and 2 μm or less, and an average particle size (D₅₀) of the third metal magnetic powder may be 25 μm or more and 30 μm or less.

The body may include a magnetic material. The magnetic material may include metal magnetic particles, and the metal magnetic particles may include two or more powders having different compositions.

The metal magnetic particles may include iron (Fe).

The coil electronic component may further include a third margin in a third direction, the third direction intersecting both the first and second directions, wherein the third margin is a distance from the coil to a surface of the body intersecting the third direction, and is 100 μm or more and 500 μm or less.

A cross-section of the coil may be circular or elliptical.

The coil electronic component may further include a first external electrode and a second external electrode that are respectively connected to the coil on a surface of the body intersecting a third direction which intersects the first direction.

The first external electrode may include a first metal layer in contact with the surface of the body intersecting the third direction, and a second metal layer that covers the first metal layer, and the second external electrode may include a first metal layer in contact with the surface of the body intersecting the third direction, and a second metal layer covering the first metal layer.

The first external electrode may further include a third metal layer that covers the second metal layer, and the second external electrode may further include a third metal layer that covers the second metal layer.

The first metal layer may include copper (Cu), the second metal layer may include nickel (Ni), and the third metal layer may include tin (Sn).

The first external electrode may extend to the surface of the body intersecting the first direction, and the second external electrode may extend to a surface opposite the surface of the body intersecting the first direction.

The first external electrode may extend to a surface opposite the surface of the body intersecting the third direction, and the second external electrode may extend to a surface opposite the surface of the body intersecting the third direction.

The first external electrode may extend to the surface of the body intersecting a second direction which intersects both the first and third directions, and the second external electrode may extend to the surface of the body intersecting the second direction.

The body may include a magnetic material. The magnetic material may include a first metal magnetic powder having an average particle size (D₅₀) of 0.1 μm or more and 0.2 μm or less, a second metal magnetic powder having an average particle size (D₅₀) of 1 μm or more and 2 μm or less, and a third metal magnetic powder having an average particle size (D₅₀) of 25 μm or more and 30 μm or less.

The coil electronic component may further include a first external electrode and a second external electrode that are respectively connected to the coil on a same surface of the body intersecting a third direction, the third direction intersecting the first direction.

The coil may include a lead-out terminal extending to the same surface of the body intersecting the third direction to connect to the first external electrode and the second external electrode.

The first external electrode and the second external electrode may be disposed only on the same surface of the body intersecting the third direction.

According to the coil electronic components according to the embodiment, the capacity to volume ratio may be increased by reducing the distance between the end surface in the length direction of the main body and the coil.

### BRIEF DESCRIPTION OF THE DRAWINGS

FIG. 1 schematically illustrates a perspective view of a coil electronic component according to an embodiment.

FIG. 2 illustrates a perspective view of an internal structure of the coil electronic component in FIG. 1.

FIG. 3 illustrates a top plan view of the internal structure of the coil electronic component in FIG. 1.

FIG. 4 illustrates a cross-sectional view taken along line IV-IV′ in FIG. 1.

FIG. 5 illustrates a cross-sectional view taken along line V-V′ in FIG. 1.

FIG. 6 illustrates an enlarged view of area “A” in FIG. 4.

FIG. 7 schematically illustrates a cross-sectional view of the coil electronic component in FIG. 1 mounted on a circuit board.

FIG. 8 schematically illustrates a cross-sectional view of a coil electronic component according to another embodiment.

FIG. 9 schematically illustrates a cross-sectional view of a coil electronic component according to yet another embodiment.

### DETAILED DESCRIPTION

The present disclosure will be described more fully hereinafter with reference to the accompanying drawings, in which embodiments of the disclosure are shown. The drawings and description are to be regarded as illustrative in nature and not restrictive. Like reference numerals designate like elements throughout the specification. In addition, some constituent elements are exaggerated, omitted, or briefly illustrated in the added drawings, and sizes of the respective constituent elements do not reflect the actual sizes.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including ordinal numbers such as first, second, and the like will be used only to describe various constituent elements, and are not to be interpreted as limiting these constituent elements. The terms are only used to differentiate one constituent element from other constituent elements.

It will be understood that when an element such as a layer, film, region, area, or substrate is referred to as being “on” or “above” another element, it can be directly on the other element or intervening elements may also be present. In contrast, when an element is referred to as being “directly on” another element, there are no intervening elements present. Further, in the specification, the word “on” or “above” means disposed on or below the object portion, and does not necessarily mean disposed on the upper side of the object portion based on a gravitational direction.

Throughout the specification, it should be understood that the term “include”, “comprise”, “have”, or “configure” indicates that a feature, a number, a step, an operation, a constituent element, a part, or a combination thereof described in the specification is present, but does not exclude a possibility of presence or addition of one or more other features, numbers, steps, operations, constituent elements, parts, or combinations, in advance. Unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Furthermore, throughout the specification, “connected” does not only mean when two or more elements are directly connected, but also when two or more elements are indirectly connected through other elements, and when they are physically connected or electrically connected, and further, it may be referred to by different names depending on a position or function, and may also be referred to as a case in which respective parts that are substantially integrated are linked to each other.

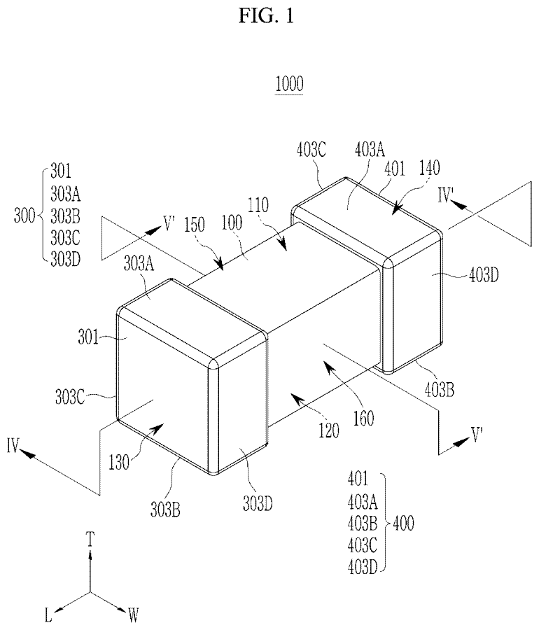

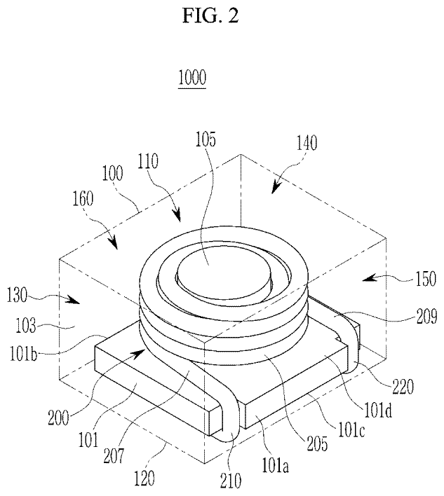

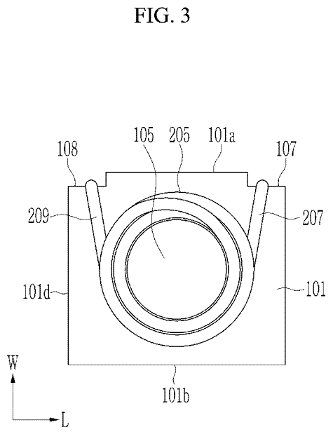

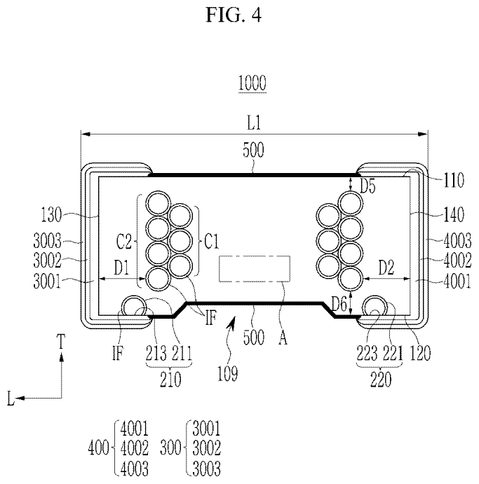

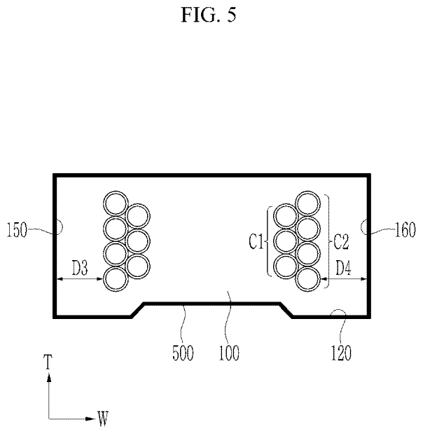

FIG. 1 schematically illustrates a perspective view of a coil electronic component according to an embodiment, FIG. 2 illustrates a perspective view of an internal structure of the coil electronic component in FIG. 1, FIG. 3 illustrates a top plan view of the internal structure of the coil electronic component in FIG. 1, FIG. 4 illustrates a cross-sectional view taken along line IV-IV′ in FIG. 1, and FIG. 5 illustrates a cross-sectional view taken along line V-V′ in FIG. 1.

Referring to FIG. 1, FIG. 2, FIG. 3, FIG. 4, and FIG. 5, a coil electronic component 1000 according to an embodiment includes a main body 100, a wire-wound coil 200, a first external electrode 300 and a second external electrode 400.

The main body 100 may have a substantially hexahedral shape, but the present embodiment is not limited thereto. Due to contraction of magnetic powder or the like during sintering, the main body 100 may have a substantially hexahedral shape, although not a perfect hexahedral shape. For example, the main body 100 has a substantially rectangular hexahedral shape, but corner or vertex portions may have a rounded shape.

In the present embodiment, for better understanding and ease of description, two surfaces facing each other in a thickness direction (a T-axis direction; third direction) are defined as a first surface 110 and a second surface 120, respectively; two surfaces facing each other in a length direction (an L-axis direction; first direction) are defined as a third surface 130 and a fourth surface 140, respectively; and two surfaces facing each other in a width direction (a W-axis direction; second direction) are defined as a fifth surface 150 and a sixth surface 160, respectively.

A length, L1, of the coil electronic component 1000 may mean, based on an optical microscope or scanning electron microscope (SEM) photograph of a cross-section taken in the length direction (L-axis direction)-the thickness direction (T-axis direction) at a center of the coil electronic component 1000 in the width direction (W-axis direction), a maximum value of lengths of a plurality of line segments that connect two outermost boundary lines facing each other in the length direction (L-axis direction) of the coil electronic component 1000 shown in the above cross-sectional photograph and are parallel to the length direction (L-axis direction). Alternatively, the length of the coil electronic component 1000 may mean a minimum value of lengths of a plurality of line segments that connect two outermost boundary lines facing each other in the length direction (L-axis direction) of the coil electronic component 1000 shown in the above cross-sectional photograph and are parallel to the length direction (L-axis direction). Alternatively, the length of the coil electronic component 1000 may mean an arithmetic mean value of lengths of at least two of a plurality of line segments that connect two outermost boundary lines facing each other in the length direction (L-axis direction) of the coil electronic component 1000 shown in the above cross-sectional photograph and are parallel to the length direction (L-axis direction). Other methods and/or tools appreciated by one of ordinary skill in the art, even if not described in the present disclosure, may also be used.

A thickness of the coil electronic component 1000 may mean, based on an optical microscope or scanning electron microscope (SEM) photograph of a cross-section in the length direction (L-axis direction)-the thickness direction (T-axis direction) at a center of the coil electronic component 1000 in the width direction (W-axis direction), a maximum value of lengths of a plurality of line segments that connect two outermost boundary lines facing each other in the thickness direction (T-axis direction) of the coil electronic component 1000 shown in the above cross-sectional photograph and are parallel to the thickness direction (T-axis direction). Alternatively, the thickness of the coil electronic component 1000 may mean a minimum value of lengths of a plurality of line segments that connect two outermost boundary lines facing each other in the thickness direction (T-axis direction) of the coil electronic component 1000 shown in the above cross-sectional photograph and are parallel to the thickness direction (T-axis direction). Alternatively, the thickness of the coil electronic component 1000 may mean an arithmetic mean value of lengths of at least two of a plurality of line segments that connect two outermost boundary lines facing each other in the thickness direction (T-axis direction) of the coil electronic component 1000 shown in the above cross-sectional photograph and are parallel to the thickness direction (T-axis direction).

A width of the coil electronic component 1000 may mean, based on an optical microscope or scanning electron microscope (SEM) photograph of a cross-section in the length direction (L-axis direction)—the width direction (W-axis direction) at a center of the coil electronic component 1000 in the thickness direction (T-axis direction), a maximum value of lengths of a plurality of line segments that connect two outermost boundary lines facing each other in the width direction (W-axis direction) of the coil electronic component 1000 shown in the above cross-sectional photograph and are parallel to the width direction (W-axis direction). Alternatively, the width of the coil electronic component 1000 may mean a minimum value of lengths of a plurality of line segments that connect two outermost boundary lines facing each other in the width direction (W-axis direction) of the coil electronic component 1000 shown in the above cross-sectional photograph and are parallel to the width direction (W-axis direction). Alternatively, the width of the coil electronic component 1000 may mean an arithmetic mean value of lengths of at least two of a plurality of line segments that connect two outermost boundary lines facing each other in the width direction (W-axis direction) of the coil electronic component 1000 shown in the above cross-sectional photograph and are parallel to the width direction (W-axis direction).

Meanwhile, each of the length, the width, and the thickness of the coil electronic component 1000 may be measured by a micrometer measurement method. The micrometer measurement method may be performed by setting a zero point by using Gage R&R (repeatability and reproducibility), inserting the coil electronic component 1000 according to the present embodiment between tips of the micrometer, and rotating a measurement lever of the micrometer. Meanwhile, when measuring the length of the coil electronic component 1000 by using the micrometer measurement method, the length of the coil electronic component 1000 may mean a value measured once, or may mean an arithmetic mean of values measured multiple times. The same may also apply to the measurement of the width and thickness of the coil electronic component 1000.

The main body 100 comprises the exterior of the coil electronic component 1000, and is a space in which a magnetic path is formed, a path through which the magnetic flux induced in the wire-wound coil 200 passes when current is applied to the wire-wound coil 200 via the first and second external electrodes 300, 400.

The main body 100 includes a base portion 101 and a cover portion 103. The base portion 101 may include a protruding portion 105.

The base portion 101 may have a front surface 101a and a rear surface 101b facing each other in the width direction (W-axis direction), and a lower surface 101c and an upper surface 101d facing each other in the thickness direction (T-axis direction). The lower surface 101c of the base portion 101 may comprise the second surface 120 of the main body 100.

The protruding portion 105 may be disposed on the upper surface 101d of the base portion 101, and the protruding portion 105 may be integral with the base portion 101. A shape of the protruding portion 105 viewed in the thickness direction (T-axis direction) is not particularly limited, and may be a circle, an ellipse, a polygon such as a triangle, or a quadrangle. The protruding portion 105 may have various known shapes that may be accommodated in a core of the wire-wound coil 200. For example, the shape of the protruding portion may be the same shape as a cross-sectional shape of the core of the wire-wound coil.

The base portion 101 may be formed by filling a mold with a magnetic material. The base portion 101 may be formed by filling a mold with a composite material including a magnetic material and an insulating resin.

The cover portion 103 may be disposed on the upper side of the base portion 101 based on FIG. 2 to surround all surfaces of the base portion 101 except for the lower surface 101c. Therefore, the cover portion 103 may comprise the first surface 110, the third surface 130, the fourth surface 140, the fifth surface 150, and the sixth surface 160 of the main body 100, and the base portion 101 and the cover portion 103 may together comprise the second surface 120 of the main body 100. At least one of the base portion 101 and the cover portion 103 may include a magnetic material, and may be made of magnetic particles an insulating resin interposed between the magnetic particles.

The magnetic material may include a first metal magnetic powder, a second metal magnetic powder with a larger particle size than the first metal magnetic powder, and a third metal magnetic powder with a larger particle size than the second metal magnetic powder. An average particle diameter D₅₀ of the first metal magnetic powder may be 0.1 μm or more and 0.2 μm or less, and an average particle diameter D₅₀ of the second metal magnetic powder may be 1 μm or more and 2 μm or less, and an average particle diameter D₅₀ of the third metal magnetic powder may be 25 μm or more and 30 μm or less.

The magnetic particle may be a ferrite particle or a metal magnetic particle having magnetic properties.

The ferrite particles may include, for example, at least one or more of a spinel-type ferrite such as Mg—Zn, Mn—Zn, Mn—Mg, Cu—Zn, Mg—Mn—Sr, and Ni—Zn; a hexagonal-type ferrite such as Ba—Zn, Ba—Mg, Ba—Ni, Ba—Co, and Ba—Ni—Co; a garnet type ferrite such as Y-type; and a Li-type ferrite.

The metal magnetic particle may comprise two or more powders of different composition, and may include one or more of iron (Fe), silicon (Si), chromium (Cr), cobalt (Co), molybdenum (Mo), aluminum (Al), niobium (Nb), copper (Cu), and nickel (Ni). For example, the metal magnetic particle may be at least one or more of pure iron, Fe—Si-based alloy, Fe—Si—Al-based alloy, Fe—Ni-based alloy, Fe—Ni—Mo-based alloy, Fe—Ni—Mo—Cu-based alloy, Fe—Co-based alloy, Fe—Ni—Co-based alloy, Fe—Cr-based alloy, Fe—Cr—Si-based alloy, Fe—Si—Cu—Nb-based alloy, Fe—Ni—Cr-based alloy, and Fe—Cr—Al-based alloy. Here, different compositions of the metal magnetic particles may also mean different contents.

The metal magnetic particle may be amorphous or crystalline. For example, the metal magnetic particle may be an Fe—Si—B—Cr-based amorphous alloy, but the present embodiment is not limited thereto. The metal magnetic particles may have an average particle diameter of about 0.1 μm to about 30 μm, but are not limited thereto. In the present specification, the average particle diameter may mean a particle size distribution expressed as D₉₀ or D₅₀. The particle size distribution is well known to those skilled in the art as an indicator of what proportion of particles of what size (particle diameter) are contained within a population of particles to be measured. D₅₀ (a particle size corresponding to 50% of a cumulative volume of the particle size distribution) refers to an average particle size. D₅₀ and D₉₀ may be measured by a scanning electron microscope (SEM). Other methods and/or tools appreciated by one of ordinary skill in the art, even if not described in the present disclosure, may also be used.

The metal magnetic particle may include two or more types of different metal magnetic particles. Here, by different types of metal magnetic particles, it is meant that the metal magnetic particles are distinguished from each other in at least one of an average particle size, composition, component ratio, crystallinity, and shape.

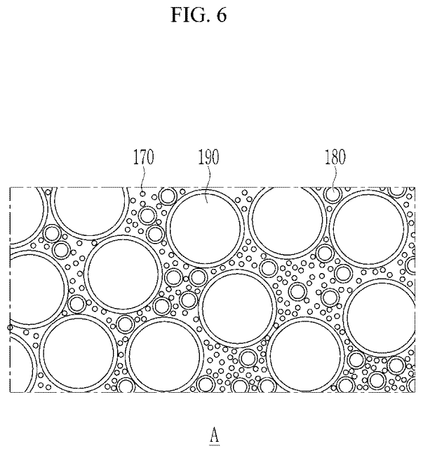

For example, referring to FIG. 6, the metal magnetic particles may include three types of metal magnetic powders (ultrafine powder 170, fine powder 180, coarse powder 190) having different particle sizes. The fine powder 180 is a magnetic powder with a larger particle size than the ultrafine powder, and the coarse powder 190 is a magnetic powder with a larger particle size than the fine powder 180. For example, the ultrafine powder 170 may be a magnetic powder having an average particle size (D₅₀) of 0.1 μm or more and 0.2 μm or less, the fine powder 180 may be a magnetic powder having an average particle size (D₅₀) of 1 μm or more and 2 μm or less, and the coarse powder 190 may be a magnetic powder having an average particle size (D₅₀) of 25 μm or more and 30 μm or less. In this way, when three types of metal magnetic powders having different particle sizes are used, a filling rate of the magnetic powders may be increased compared to the case in which only one type of metal magnetic powder is used.

The insulating resin may include, but is not limited to, epoxy, polyimide, and liquid crystal polymer, and the like, either alone or in combination.

A method for forming the main body 100 is not particularly limited. For example, the main body 100 may be formed by disposing magnetic sheets on the upper and lower portions of the wire-wound coil 200 and then compressing and curing them.

The wire-wound coil 200 is embedded in the main body 100, thereby exhibiting characteristics of the coil electronic component 1000. For example, when the coil electronic component 1000 of the present embodiment is used as a power inductor, the wire-wound coil 200 may serve to stabilize power source of an electronic device by storing an electric field as a magnetic field and maintaining an output voltage.

The wire-wound coil 200 may have a shape in which a metal (for example, copper (Cu) or silver (Ag)) wire coated with an insulating material is spirally wound. The wire-wound coil 200 is not limited to a single wire, and may comprise a stranded wire or two or more wires.

The wire-wound coil 200 may be an air coil, wound around the protruding portion 105 of the base portion 101. The wire-wound coil 200 may be a circular coil, but is not limited thereto. For example, the wire-wound coil 200 may be a variety of well-known coils such as a rectangular coil. As another example, the wire-wound coil 200 may be a coil using a magnetic material or iron core ferrite as a core.

Cross-sections of individual wires of the wire-wound coil 200 may have various well-known shapes such as a square, a circle, and an ellipse.

The wire-wound coil 200 may have a plurality of turns. That is, the wire-wound coil 200 may have an innermost turn coil C1 and an outermost turn coil C2 in sequence from a midpoint of a length L1 of the coil electronic component 1000 toward the third surface 130. Meanwhile, at least one intermediate turn coil may be disposed between the innermost turn coil C1 and the outermost turn coil C2.

A first lead portion 207 may extend from an end of the outermost turn coil C2, and a second lead portion 209 may extend from an end of the innermost turn coil C1.

An insulating film IF may be disposed along a surface of each of a plurality of turns of the wire-wound coil 200. The insulating film IF is for protecting and insulating the plurality of turns of each wire-wound coil 200, and may include a known insulating material such as parylene. Any insulating material may be used in the insulating film IF, and there is no particular limitation. For example, the insulating film IF may be a polyurethane resin, a polyester resin, an epoxy resin, or a polyamideimide resin. The insulating film IF may be formed by a method such as vapor deposition, but is not limited thereto.

The wire-wound coil 200 may include a spiral portion 205, the first lead portion 207, the second lead portion 209, a first lead-out terminal 210, and a second lead-out terminal 220.

The spiral portion 205 is a portion where a wire of the wire-wound coil 200 is wound.

The first lead portion 207 and the second lead portion 209 each extend from the spiral portion 205. For example, the first and second lead portions 207 and 209 may extend from the rear surface 101b side of the base portion 101 through the front surface 101a to the lower surface 101c side. However, the present embodiment is not limited thereto, and the first and second lead portions may extend in various directions.

The first lead-out terminal 210 substantially extends from the first lead portion 207 in the thickness direction (T-axis direction), and has a shape that is drawn out to the lower surface 101c of the base portion 101. The second lead-out terminal 220 substantially extends from the second lead portion 209 in the thickness direction (T-axis direction), and has a shape that is drawn out to the lower surface 101c of the base portion 101.

Grooves 107 and 108 may be disposed in the base portion 101. For example, the grooves 107 and 108 may be disposed across the front surface 101a, the lower surface 101c, and the rear surface 101b of the base portion 101 on both sides in the length direction (L-axis direction). The grooves 107 and 108 may guide the lead-out terminals 210 and 220. However, the groove does not necessarily have to be disposed on the base portion, and the groove may not be present depending on the method of forming the base portion or the arrangement of the lead-out terminals.

On the lower surface 101c of the base portion 101, a recess portion 109 may be formed on a portion facing the protruding portion 105. When the recess portion 109 is included, a metal particle filling rate of the protruding portion 105 may be further increased by compression molding. The shape of the recess portion 109 viewed from the lower surface side of the base portion 101 is not particularly limited, and may be in a shape of a circle, an ellipse, a polygonal shape such as a triangle or a quadrangle, or a belt.

The recess portion 109 exists between the first external electrode 300 and the second external electrode 400. By providing the recess portion 109 between the first external electrode 300 and the second external electrode 400, the path length between the first external electrode 300 and the second external electrode 400 (a distance along the lower surface) may be increased, which may improve electrical insulation between the first external electrode 300 and the second external electrode 400 and increase reliability. In addition, by providing the recess portion 109 between the first external electrode 300 and the second external electrode 400, when implemented on a substrate or the like, the minimum distance between the substrate and the lower surface of the base portion 101 may be increased, thereby increasing reliability. Since an insulating layer may be accommodated in the recess portion, the thickness of the coil electronic component may be reduced compared to a case where the recess portion is not formed.

A cross-sectional shape of the first lead-out terminal 210 along the length direction (L-axis direction) and the thickness direction (T-axis direction) of the main body 100 may be a circular shape with a portion cut off. That is, the cross-section of the first lead-out terminal 210 has a first terminal surface 211 and a second terminal surface 213. The first terminal surface 211 has an arc shape, and the second terminal surface 213 has a straight line shape.

The first terminal surface 211 may be embedded in the main body 100 to be connected to the first lead portion 207 of the wire-wound coil 200.

The second terminal surface 213 may flush with the second surface 120 of the main body 100 or may be exposed from the second surface 120. The second terminal surface 213 may be connected to the first external electrode 300.

A cross-sectional shape of the second lead-out terminal 220 along the length direction (L-axis direction) and the thickness direction (T-axis direction) of the main body 100 may also be a circular shape with a portion cut off. That is, the cross-section of the second lead-out terminal 220 has a first terminal surface 221 and a second terminal surface 223. The first terminal surface 221 has an arc shape, and the second terminal surface 222 has a straight line shape.

The first terminal surface 221 may be embedded in the main body 100 to be connected to the second lead portion 209 of the wire-wound coil 200.

The second terminal surface 223 may be flush with the second surface 120 of the main body 100 or may be exposed from the second surface 120. The second terminal surface 222 may be connected to the second external electrode 400.

The first lead-out terminal 210 and the second lead-out terminal 220 may be spaced apart from each other and parallel to each other along the length direction (L-axis direction) of the main body 100.

The first external electrode 300 and the second external electrode 400 are disposed outside the main body 100 and are connected to the wire-wound coil 200. That is, the first external electrode 300 is connected to the first lead-out terminal 210 of the wire-wound coil 200, and the second external electrode 400 is connected to the second lead-out terminal 220 of the wire-wound coil 200.

The first external electrode 300 is connected to the first lead-out terminal 210 of the wire-wound coil 200 on the second surface 120 of the main body 100, and extends to the first end surface (third surface) 130, the first surface 110, the fifth surface 150, and the sixth surface 160.

The second external electrode 300 is connected to the second lead-out terminal 220 of the wire-wound coil 200 on the second surface 120 of the body 100, and extends to the second end surface (fourth surface) 140, the first surface 110, the fifth surface 150, and the sixth surface 160.

For example, the first and second external electrodes 300 and 400 may be disposed at both ends of the length direction (L-axis direction) of the main body 100. The first external electrode 300 may include a first end surface 301, a first upper surface 303A, a first lower surface 303B, a first side surface 303C, and a second side surface 303D, and the second external electrode 400 may include a second end surface 401, a second upper surface 403A, a second lower surface 403B, a third side surface 403C, and a fourth side surface 403D.

The first end surface 301 of the first external electrode 300 covers the third surface 130 of the main body 100.

The second end surface 401 of the second external electrode 400 covers the fourth surface 140 of the main body 100.

The first upper surface 303A, the first lower surface 303B, the first side surface 303C, and the second side surface 303D may extend from the first end surface 301 along the length direction (L-axis direction) of the main body 100, and may cover portions of the first surface 110 and the second surface 120 of the main body 100 and portions of the fifth surface 150 and the sixth surface 160 of the main body 100. Among them, the first lower surface 303B covers a portion of the second surface 120, and is electrically connected to the first lead-out terminal 210 of the wire-wound coil 200.

The second upper surface 403A, the second lower surface 403B, the third side surface 403C, and the fourth side surface 403D may extend from the second end surface 401 along the length direction (L-axis direction) of the main body 100, and may cover portions of the first surface 110 and the second surface 120 of the main body 100 and portions of the fifth surface 150 and the sixth surface 160 of the main body 100. Among them, the second lower surface 403B covers a portion of the second surface 120, and is electrically connected to the second lead-out terminal 220 of the wire-wound coil 200.

The first and second external electrodes 300 and 400 may comprise a conductive material such as copper (Cu), aluminum (Al), silver (Ag), tin (Sn), gold (Au), nickel (Ni), lead (Pb), chromium (Cr), titanium (Ti), or an alloy thereof, but are not limited thereto.

The first and second external electrodes 300 and 400 may include a plurality of metal layers formed by plating conductive metal.

The first external electrode 300 may include a first metal layer 3001, a second metal layer 3002, and a third metal layer 3003.

The first metal layer 3001 is a plating layer that is in contact with an outer surface of the main body 100, and may include copper (Cu). The second metal layer 3002 may be a plating layer that covers the first metal layer 3001 and include nickel (Ni). The third metal layer 3003 may be a plating layer that covers the second metal layer 3002 and include tin (Sn). However, the present embodiment is not limited to the three-layer structure described above, and a two-layer structure with only one plating layer added on the first metal layer 3001 is also possible.

The second external electrode 400 may include a first metal layer 4001, a second metal layer 4002, and a third metal layer 4003.

The first metal layer 4001 is a plating layer that is in contact with an outer surface of the main body 100, and may include copper (Cu). The second metal layer 4002 may be a plating layer that covers the first metal layer 4001 and may include nickel (Ni). The third metal layer 4003 may be a plating layer that covers the second metal layer 4002 and include tin (Sn). However, the present embodiment is not limited to the three-layer structure described above, and a two-layer structure with only one plating layer added on the first metal layer 4001 is also possible.

As described above, the first and second external electrodes 300 and 400 may include nickel (Ni), copper (Cu), palladium (Pd), gold (Au), or an alloy thereof, and may include a plurality of plating layers. For example, each of the first and second external electrodes 300 and 400 may be made of a combination of a nickel (Ni) layer, copper (Cu) layer, nickel/copper (Ni/Cu) layer, palladium/nickel (Pd/Ni) layer, palladium/nickel/copper (Pd/Ni/Cu) layer, and copper/nickel/copper (Cu/Ni/Cu) layer.

In some embodiments, the outermost layer may be made of tin (Sn). Since the tin plating layer has a relatively low melting point, it can improve the ease of mounting the first and second external electrodes 300 and 400 on a substrate.

Generally, the tin plating layer may be bonded to an electrode pad on a substrate through a solder including a tin (Sn)-copper (Cu)-silver (Ag) alloy paste. That is, the tin plating layer may melt and bond with the solder during the heat treatment (reflow) process.

Referring to FIG. 4, a distance between the third surface 130 of the main body 100 and the outermost turn coil C2 toward the third surface 130 of the wire-wound coil 200 is a first distance D1, a distance between the fourth surface 140 of the main body 100 and the outermost turn coil C2 toward the fourth surface 140 of the wire-wound coil 200 is a second distance D2, and an arithmetic mean value (hereinafter referred to as an “L-direction margin”) Lm of the first distance D1 and the second distance D2 may be greater than 0% and 7% or less of the length L1 of the coil electronic component 1000.

Here, the first distance D1 may mean, based on an optical microscope or scanning electron microscope (SEM) photograph of a cross-section taken in the length direction (L-axis direction)-thickness direction (T-axis direction) at the center point of the coil electronic component 1000 in the width direction (W-axis direction), an arithmetic mean value of values that measure the distance from the third surface 130 of the main body 100 shown in the above cross-sectional photograph to the outermost turn coil C2, at three equally spaced points on each outermost turn coil. Other methods and/or tools appreciated by one of ordinary skill in the art, even if not described in the present disclosure, may also be used.

Here, the second distance D2 may mean, based on an optical microscope or scanning electron microscope (SEM) photograph of a cross-section taken in the length direction (L-axis direction)-thickness direction (T-axis direction) at the center point of the width of the coil electronic component 1000, an arithmetic mean value of values that measure the distance from the fourth surface 140 of the main body 100 shown in the above cross-sectional photograph to the outermost turn coil C2, at three equally spaced points on each outermost turn coil. Other methods and/or tools appreciated by one of ordinary skill in the art, even if not described in the present disclosure, may also be used.

When the L-direction margin Lm exceeds 7% of the length L1 of the coil electronic component 1000, a distance between the wire-wound coil 200 and the third surface 130 of the main body 100 or a distance between the wire-wound coil 200 and the fourth surface 140 of the main body 100 is too large. Under the condition that the length of the coil electronic component 1000 is the same, the larger the first distance D1 or the second distance D2, the more the wire-wound coil 200 is disposed more toward the center of the main body 100. As a result, the area of the magnetic path is reduced by that much, which may lead to a reduction in capacity. For example, a conventional coil electronic component having the L-direction margin Lm of 9% or more may not sufficiently secure a capacity to volume ratio, or may have limitations in a saturation current (Isat), a DC resistance of the winding (Rdc, copper loss), the number of turns of coil, and the like.

In the coil electronic component according to the present embodiment, the problem of the conventional coil electronic component may be solved by setting the L-direction margin Lm to 7% or less of the length L1 of the coil electronic component 1000.

Referring to FIG. 5, a distance between the fifth surface 150 of the main body 100 and the outermost turn coil C2 toward the fifth surface 150 of the wire-wound coil 200 is a third distance D3, and a distance between the sixth surface 160 of the main body 100 and the outermost turn coil C2 toward the sixth surface 160 of the wire-wound coil 200 is a fourth distance D4. An arithmetic mean value (hereinafter referred to as a “W-direction margin”) Wm of the third distance D3 and the fourth distance D4 may be smaller than the L-direction margin Lm.

Here, the third distance D3 may mean, based on an optical microscope or scanning electron microscope (SEM) photograph of a cross-section taken in the width direction (W-axis direction)-thickness direction (T-axis direction) at the center point of the coil electronic component 1000 in the length direction (L-axis direction), an arithmetic mean value of values that measure the distance from the fifth surface 150 of the main body 100 shown in the above cross-sectional photograph to the outermost turn coil C2, at three equally spaced points on each outermost turn coil. Other methods and/or tools appreciated by one of ordinary skill in the art, even if not described in the present disclosure, may also be used.

Here, the fourth distance D4 may mean, based on an optical microscope or scanning electron microscope (SEM) photograph of a cross-section taken in the width direction (W-axis direction)-thickness direction (T-axis direction) at the center point of the coil electronic component 1000 in the length direction (L-direction), an arithmetic mean value of values that measure the distance from the sixth surface 160 of the main body 100 shown in the above cross-sectional photograph to the outermost turn coil C2, at three equally spaced points on each outermost turn coil. Other methods and/or tools appreciated by one of ordinary skill in the art, even if not described in the present disclosure, may also be used.

If the W-direction margin Wm is greater than the L-direction margin Lm, there may be a problem in that an inductance (Ls) characteristic may deteriorate. In the present embodiment, the aforementioned problem may be prevented from occurring by making the L-direction margin Lm larger than the W-direction margin Wm.

Referring to FIG. 4, a distance between the first surface 110 of the main body 100 and the outermost turn coil C2 toward the first surface 110 of the wire-wound coil 200 is a fifth distance D5, and a distance between the second surface 120 of the main body 100 and the outermost turn coil C2 toward the second surface 120 of the wire-wound coil 200 is a sixth distance D6.

Here, the fifth distance D5 may mean, based on an optical microscope or scanning electron microscope (SEM) photograph of a cross-section taken in the length direction (L-axis direction)-thickness direction (T-axis direction) at the center point of the coil electronic component 1000 in the width direction (W-axis direction), an arithmetic mean value of values that measure the distance from the first surface 110 of the main body 100 shown in the above cross-sectional photograph to the outermost turn coil C2, at three equally spaced points on each outermost turn coil. Other methods and/or tools appreciated by one of ordinary skill in the art, even if not described in the present disclosure, may also be used.

Here, the sixth distance D6 may mean, based on an optical microscope or scanning electron microscope (SEM) photograph of a cross-section taken in the length direction (L-axis direction)-thickness direction (T-axis direction) at the center point of the coil electronic component 1000 in the width direction (W-axis direction), an arithmetic mean value of values that measure the distance from the second surface 120 of the main body 100 shown in the above cross-sectional photograph to the outermost turn coil C2, at three equally spaced points on each outermost turn coil. Other methods and/or tools appreciated by one of ordinary skill in the art, even if not described in the present disclosure, may also be used.

Both the fifth distance D5 and the sixth distance D6 (hereinafter referred to as a “T-direction margin”) Tm may be 100 μm or more and 500 μm or less. If the fifth distance D5 or the sixth distance D6 is less than 100 μm, defects such as chipping may occur, and if the fifth distance D5 or the sixth distance D6 exceeds 500 μm, the inductance Ls characteristic may deteriorate.

Meanwhile, in the main body 100 of the coil electronic component 1000 according to the present embodiment, the insulating layer 500 may be disposed in regions other than regions in which the first and second external electrodes 300 and 400 are disposed. Alternatively, an insulating layer may be present in a region between an exposed portion of the first lead-out terminal 210 and an exposed portion of the second lead-out terminal 220 on the second surface 120 of the main body 100. In this case, the first and second external electrodes 300 and 400 may cover a portion of the insulating layer.

The insulating layer may be used as a resist when forming the external electrodes 300 and 400 by electroplating, but is not limited thereto.

The insulating layer may be disposed on at least some of the first surface 110, the second surface 120, the fifth surface 150, and the sixth surface 160 of the main body 100 to prevent an electrical short circuit between other electronic components and the external electrodes 300 and 400.

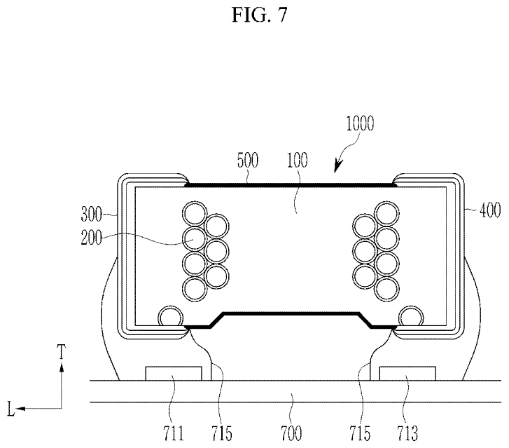

FIG. 7 illustrates a schematic cross-sectional view of the coil electronic component shown in FIG. 1 mounted on a substrate.

Referring to FIG. 7, the coil electronic component 1000 is connected to first and second electrode pads 711 and 713 on an upper surface of a circuit board 700 through a conductive bonding member 715. That is, the coil electronic component 1000 may be mounted on the circuit board 700 through the first and second electrode pads 711 and 713.

The first and second electrode pads 711 and 713 may be disposed apart from each other on the upper surface of the circuit board 700. In a state in which the first external electrode 300 of the coil electronic component 1000 is in contact with the first electrode pad 711 and the second external electrode 400 thereof is in contact with the second electrode pad 713, the first external electrode 300 and the second external electrode 400 may be bonded to the circuit board 700 by the conductive bonding member 715. Accordingly, the coil electronic component 1000 may be electrically connected to the first and second electrode pads 711 and 713 of the circuit board 700. The conductive bonding member 715 may include, for example, solder.

In the present embodiment, the first external electrode 300 of the coil electronic component 1000 is bonded to the first electrode pad 711 by the conductive bonding member 715 and the second external electrode 400 thereof is bonded to the second electrode pad 713 by the conductive bonding member 715, so that they are mounted on the circuit board 700.

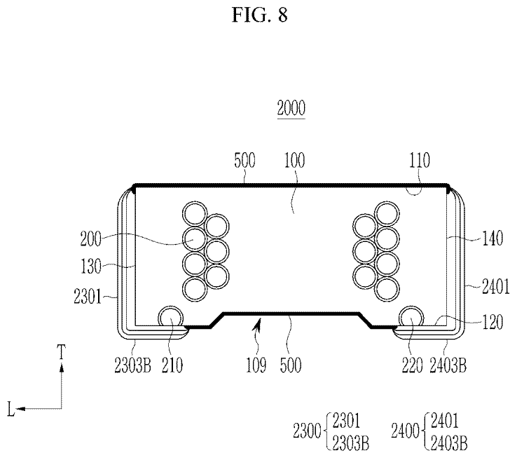

FIG. 8 illustrates a schematic cross-sectional view of a coil electronic component according to another embodiment.

Referring to FIG. 8, a first external electrode 2300 of a coil electronic component 2000 according to another embodiment is connected to the first lead-out terminal 210 of the wire-wound coil 200 on the second surface 120 of the main body 100 and extends to the third surface 130. In addition, a second external electrode 2400 is connected to the second lead-out terminal 220 of the wire-wound coil 200 on the second surface 120 of the main body 100 and extends to the fourth surface 140.

For example, the first external electrode 2300 may include a first end surface 2301 and a first lower surface 2303B, and the second external electrode 2400 may include a second end surface 2401 and a second lower surface 2403B.

The insulating layer 500 covers the second surface 120 of the main body 100 between the first lower surface 2303B and the second lower surface 2403B. In addition, the insulating layer 500 completely covers the first surface 110, the fifth surface 150 (see FIG. 1), and the sixth surface 160 (see FIG. 1) of the main body 100.

Components except for the above-described components are the same as those of the coil electronic component shown in FIG. 1, so redundant descriptions thereof will be omitted.

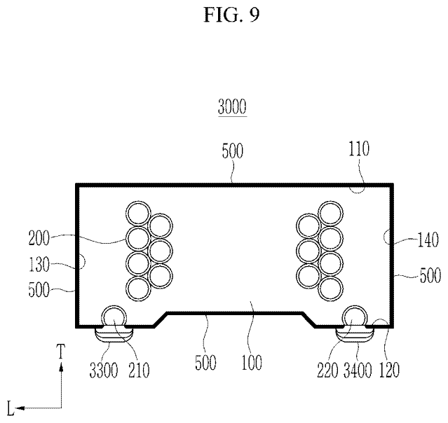

FIG. 9 illustrates a schematic cross-sectional view of a coil electronic component according to another embodiment.

Referring to FIG. 9, a first external electrode 3300 of a coil electronic component 3000 according to another embodiment is connected to the first lead-out terminal 210 of the wire-wound coil 200 on the second surface 120 of the main body 100 and partially covers the second surface 120, and a second external electrode 3400 thereof is connected to the second lead-out terminal 220 of the wire-wound coil 200 on the second surface 120 of the main body 100 and partially covers the second surface 120. For example, both the first external electrode 3300 and the second external electrode 3400 may be disposed on the second surface 120 of the main body 100, and the second external electrode 3400 may face the first external electrode 3300 in the length direction L.

The insulating layer 500 covers the second surface 120 of the main body 100 between the first external electrode 3300 and the second external electrode 3400. Meanwhile, since the first and second external electrodes 3300 and 3400 are disposed only on the second surface 120 of the main body 100, the insulating layer 500 covers all of the third surface 130, the fourth surface 140, the first surface 110, the fifth surface 150 (see FIG. 1), and the sixth surface 160 (see FIG. 1) of the main body 100.

Components except for the above-described components are the same as those of the coil electronic component shown in FIG. 1, so redundant descriptions thereof will be omitted.

Hereinafter, specific examples of the present disclosure will be described.

However, the following described examples are provided only for illustrating the disclosure more specifically, and thus the scope of the disclosure should not be limited by these examples.

### Manufacturing Example; Manufacturing of Coil Electronic Components

### Example 1

A coil electronic component in which a ratio of the L-direction margin Lm to the length L1 of the coil electronic component is 0.5% is manufactured.

### Example 2

A coil electronic component in which a ratio of the L-direction margin Lm to the length L1 of the coil electronic component is 1.0% is manufactured.

### Example 3

A coil electronic component in which a ratio of the L-direction margin Lm to the length L1 of the coil electronic component is 1.5% is manufactured.

### Example 4

A coil electronic component in which a ratio of the L-direction margin Lm to the length L1 of the coil electronic component is 2.0% is manufactured.

### Example 5

It is the same as Example 1 except that the ratio of the L-direction margin Lm to the length L1 of the coil electronic component is 2.5%.

### Example 6

It is the same as Example 1 except that the ratio of the L-direction margin Lm to the length L1 of the coil electronic component is 3.0%.

### Example 7

It is the same as Example 1 except that the ratio of the L-direction margin Lm to the length L1 of the coil electronic component is 3.5%.

### Example 8

It is the same as Example 1 except that the ratio of the L-direction margin Lm to the length L1 of the coil electronic component is 4.0%.

### Example 9

It is the same as Example 1 except that the ratio of the L-direction margin Lm to the length L1 of the coil electronic component is 4.5%.

### Example 10

It is the same as Example 1 except that the ratio of the L-direction margin Lm to the length L1 of the coil electronic component is 5.0%.

### Example 11

It is the same as Example 1 except that the ratio of the L-direction margin Lm to the length L1 of the coil electronic component is 5.5%.

### Example 12

It is the same as Example 1 except that the ratio of the L-direction margin Lm to the length L1 of the coil electronic component is 6.0%.

### Example 13

It is the same as Example 1 except that the ratio of the L-direction margin Lm to the length L1 of the coil electronic component is 6.5%.

### Example 14

It is the same as Example 1 except that the ratio of the L-direction margin Lm to the length L1 of the coil electronic component is 7.0%.

### Comparative Example 1

It is the same as Example 1 except that the ratio of the L-direction margin Lm to the length L1 of the coil electronic component is 0.0%.

### Comparative Example 2

It is the same as Example 1 except that the ratio of the L-direction margin Lm to the length L1 of the coil electronic component is 7.5%.

### Comparative Example 3

It is the same as Example 1 except that the ratio of the L-direction margin Lm to the length L1 of the coil electronic component is 8.0%.

### Comparative Example 4

It is the same as Example 1 except that the ratio of the L-direction margin Lm to the length L1 of the coil electronic component is 8.5%.

### Experimental Example: Chipping of Coil Electronic Components and Poor Inductance

After manufacturing 30 pieces of coil electronic components for each of Examples 1 to 14 and Comparative Examples 1 to 4, the ratio (Lm/L1) of the L-direction margin Lm to the length L1 of the coil electronic component was measured; whether the chipping of the coil electronic component occurred and whether the inductance Ls was within the desired range (0.435 to 0.465 μH) were checked; and then the results are summarized in Table 1.

TABLE 1

| | L1 | Lm | Lm/L1 | Chipping | | Ls desired | |
|---|---|---|---|---|---|---|---|
| | (μm) | (μm) | (%) | occurrence | Ls (μH) | range | Conclusion |
| Comparative | 1565 | 0 | 0 | Yes | 0.468 | Out of range | Poor |
| Example 1 | | | | | | | |
| Example 1 | 1565 | 8 | 0.5 | No | 0.465 | Within range | Good |
| Example 2 | 1565 | 16 | 1 | No | 0.463 | Within range | Good |
| Example 3 | 1565 | 23 | 1.5 | No | 0.461 | Within range | Good |
| Example 4 | 1565 | 31 | 2 | No | 0.459 | Within range | Good |
| Example 5 | 1565 | 39 | 2.5 | No | 0.457 | Within range | Good |
| Example 6 | 1565 | 47 | 3 | No | 0.454 | Within range | Good |
| Example 7 | 1565 | 55 | 3.5 | No | 0.452 | Within range | Good |
| Example 8 | 1565 | 63 | 4 | No | 0.450 | Within range | Good |
| Example 9 | 1565 | 70 | 4.5 | No | 0.447 | Within range | Good |
| Example 10 | 1565 | 78 | 5 | No | 0.445 | Within range | Good |
| Example 11 | 1565 | 86 | 5.5 | No | 0.443 | Within range | Good |
| Example 12 | 1565 | 94 | 6 | No | 0.440 | Within range | Good |
| Example 13 | 1565 | 102 | 6.5 | No | 0.438 | Within range | Good |
| Example 14 | 1565 | 110 | 7 | No | 0.436 | Within range | Good |
| Comparative | 1565 | 117 | 7.5 | No | 0.433 | Out of range | Poor |
| Example 2 | | | | | | | |
| Comparative | 1565 | 125 | 8 | No | 0.431 | Out of range | Poor |
| Example 3 | | | | | | | |
| Comparative | 1565 | 133 | 8.5 | No | 0.429 | Out of range | Poor |
| Example 4 | | | | | | | |

Referring to Table 1, it can be confirmed that chipping occurred because the L-direction margin Lm of the coil electronic component manufactured in

Comparative Example 1 was too small. Meanwhile, it can be confirmed that the inductance of the coil electronic component manufactured in Examples 1 to 14 was within the desired range (0.435 to 0.465). The inductance of the coil electronic component manufactured in Comparative Examples 2 to 4 was too low and was out of the desired range (0.435 to 0.465), which was because the volume of the magnetic material and the area of the magnetic path in the core portion were relatively reduced, resulting in decreased capacity.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A coil electronic component comprising:
a body and a coil at least partially embedded in the body,
wherein the coil electronic component has a length L1 in a first direction and a first margin in the first direction,
wherein the first margin is an average distance from the coil to a surface of the body intersecting the first direction, and is greater than 0% and less than or equal to 7% of the length L1 in the first direction.

2. The coil electronic component of claim 1, further comprising
a second margin in a second direction, the second direction intersecting the first direction,
wherein the second margin is an average distance from the coil to a surface of the body intersecting the second direction, and is smaller than the first margin.

3. The coil electronic component of claim 1, wherein
the body includes a magnetic material, and
the magnetic material includes
a first metal magnetic powder,
a second metal magnetic powder with a larger particle size than the first metal magnetic powder, and
a third metal magnetic powder with a larger particle size than the second metal magnetic powder.

4. The coil electronic component of claim 3, wherein
an average particle size (D₅₀) of the first metal magnetic powder is 0.1 μm or more and 0.2 μm or less.

5. The coil electronic component of claim 3, wherein
an average particle size (D₅₀) of the second metal magnetic powder is 1 μm or more and 2 μm or less, and
an average particle size (D₅₀) of the third metal magnetic powder is 25 μm or more and 30 μm or less.

6. The coil electronic component of claim 1, wherein
the body includes a magnetic material,
the magnetic material includes metal magnetic particles, and
the metal magnetic particles include two or more powders having different compositions.

7. The coil electronic component of claim 6, wherein
the metal magnetic particles include iron (Fe).

8. The coil electronic component of claim 1, further comprising
a third margin in a third direction, the third direction intersecting both the first and second directions,
wherein the third margin is a distance from the coil to a surface of the body intersecting the third direction, and is 100 μm or more and 500 μm or less.

9. The coil electronic component of claim 1, wherein
a cross-section of the coil is circular or elliptical.

10. The coil electronic component of claim 1, further comprising
a first external electrode and a second external electrode that are respectively connected to the coil on a surface of the body intersecting a third direction, the third direction intersecting the first direction.

11. The coil electronic component of claim 10, wherein
the first external electrode includes a first metal layer in contact with the surface of the body intersecting the third direction, and a second metal layer that covers the first metal layer, and
the second external electrode includes a first metal layer in contact with the surface of the body intersecting the third direction, and a second metal layer covering the first metal layer.

12. The coil electronic component of claim 11, wherein
the first external electrode further includes a third metal layer that covers the second metal layer, and
the second external electrode further includes a third metal layer that covers the second metal layer.

13. The coil electronic component of claim 12, wherein
the first metal layer includes copper (Cu),
the second metal layer includes nickel (Ni), and
the third metal layer includes tin (Sn).

14. The coil electronic component of claim 10, wherein
the first external electrode extends to the surface of the body intersecting the first direction, and
the second external electrode extends to the surface opposite the surface of the body intersecting the first direction.

15. The coil electronic component of claim 14, wherein
the first external electrode extends to a surface opposite the surface of the body intersecting the third direction, and
the second external electrode extends to the surface opposite the surface of the body intersecting the third direction.

16. The coil electronic component of claim 15, wherein
the first external electrode extends to the surface of the body intersecting a second direction, the second direction intersecting both the first and third directions, and
the second external electrode extends to the surface of the body intersecting the second direction.

17. The coil electronic component of claim 2, wherein
the body includes a magnetic material, and
the magnetic material includes
a first metal magnetic powder having an average particle size (D₅₀) of 0.1 μm or more and 0.2 μm or less,
a second metal magnetic powder having an average particle size (D₅₀) of 1 μm or more and 2 μm or less, and
a third metal magnetic powder having an average particle size (D₅₀) of 25 μm or more and 30 μm or less.

18. The coil electronic component of claim 17, further comprising
a first external electrode and a second external electrode that are respectively connected to the coil on a same surface of the body intersecting a third direction, the third direction intersecting the first direction.

19. The coil electronic component of claim 18, wherein the coil includes a lead-out terminal extending to the same surface of the body intersecting the third direction to connect to the first external electrode and the second external electrode.

20. The coil electronic component of claim 19, wherein the first external electrode and the second external electrode are disposed only on the same surface of the body intersecting the third direction.
